(19) United States
(12) Patent Application Publication
(10) Pub. No.: US 2016/0167467 A1
(43) Pub. Date: Jun. 16, 2016

(54) METHOD FOR SIMULATING A ROLLING RADIUS OF A MOTOR VEHICLE TIRE

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Jérémy BUISSON, Clermont-Ferrand (FR); Teddy VIRIN, Clermont-Ferrand (FR)

(21) Appl. No.: 14/909,517

(22) PCT Filed: Jul. 23, 2014
(86) PCT No.: PCT/FR2014/051911

§ 371 Date: Feb. 2, 2016

(30) Foreign Application Priority Data
Aug. 2, 2013 (FR) 1357694

(51) Int. Cl. B60C 99/00; G06F 17/10

(52) U.S. Cl. CPC B60C 99/006; G06F 17/10

(57) ABSTRACT

The invention relates to a method for producing a motor vehicle tire, comprising a step of estimating the effective rolling radius Rᵣₒₗₗ of the tire by using a formula of the form in which:

$${Rroll}_{1} = {Rroll}_{11} - [ ( {κ}_{11} + {κ}_{12} * \frac{deflect}{Pg} ) ] * ( 1 - exp ( \frac{- deflect}{Pg * {Rroll}_{16}} ) )$$

$${Rroll}_{2} = ( {Rroll}_{21} + {Rroll}_{22} * sign ( δ ) * V ) * \frac{1}{{Fz}^{{Rroll}_{23}}} * ( 1 - cos ( \vert δ \vert ) ) - \frac{{Rroll}_{24}}{π} …$$

and:

Rroll₃=(κ₃₁+κ₃₂*sign(δ*γ))*(1−cos(|γ|))

The invention relates to methods for determining the rolling radius of a tire.

The rolling radius characterizes the number of revolutions necessary for the tire to cover a given distance without application of the engine torque or braking torque, that is to say with a linear speed in the area of contact that is equivalent to that of the ground, which is typically zero.

During rolling, under conditions that are typical of those met on a vehicle likely to be equipped with a given tire, the conditions cover a wide range of uses, from rolling in a straight line to rolling at high speed on a circuit.

The road holding behaviour of the vehicles makes use of complex phenomena, in particular at the tires. Taking these phenomena into account in order to understand, analyse and simulate the behaviour is essential in order to improve it. To this end, simulation tools require models that describe the contribution of the tires. Various quantities associated with the tire torsor or its rolling geometry are used; this is the case for the effective rolling radius. This is thus particularly important for taking into account the actions of acceleration and braking of a vehicle. It can thus be applied to startup strategies, such as launch control, which is carried out in competition for example or braking strategies by estimating the monitoring of a slip target of an ABS system—for Antiblockiersystem in German or anti-lock braking system—for example.

Various mathematical formulations have already been proposed to assess the change in the rolling radius of a tire. Among said formulations, different versions of the formulations known as “magic formulas” of H.B. Pacejka can be cited, the most widespread version being MF-5.2 or the final variant MF-6.1. The formulation MF-5.2 that is currently most used describes the effective rolling radius as follows:

$$ρ {F}_{z 0} = \frac{{F}_{z 0}}{{C}_{z}}$$

$${ρ}^{d} = \frac{ρ}{ρ {F}_{z 0}}$$

with ρ the deflection of the tire and C_{Z} its vertical stiffness.

Rₑ=R₀−ρ_{F}_{_{Z0}}(D arctan(Bρ^{d})+Fρ^{d})

The aim of the invention is to propose a method for estimating the rolling radius of the tire, which has greater acuity and is easier to implement.

This aim is achieved according to the invention by virtue of a method for producing a motor vehicle tire, characterized in that it comprises a step of estimating an effective rolling radius Rᵣₒₗₗ of the tire by way of a formula of the form:

Rroll=Rroll₁+Rroll₂+Rroll₃,

where:

$${Rroll}_{1} = {Rroll}_{11} - [ ( {κ}_{11} + {κ}_{12} * \frac{deflect}{Pg} ) ] * ( 1 - exp ( \frac{- deflect}{Pg * {Rroll}_{16}} ) )$$

κ₁₁=Rroll₁₂+Rroll₁₃*V

with:

κ₁₂=Rroll₁₄+Rroll₁₅*V

$${Rroll}_{2} = ( {Rroll}_{21} + {Rroll}_{22} * sign ( δ ) * V ) * \frac{1}{{Fz}^{{Rroll}_{23}}} * ( 1 - cos ( \vert δ \vert ) ) - \frac{{Rroll}_{24}}{π} … * ( 1 - exp ( \frac{- Fz}{{Rroll}_{25}} ) ) * \frac{1}{{V}^{{Rroll}_{26}}} … * [ arctan ( {Rroll}_{27} * \vert δ \vert - {Rroll}_{28} * exp ( \frac{- Fz}{{Rroll}_{29}} ) * \frac{1}{{V}^{{Rroll}_{30}}} ) + \frac{π}{2} ] .$$

and:

Rroll₃=(κ₃₁+κ₃₂*sign(δ*γ))*(1−cos(|γ|))

with:

$${κ}_{31} = {Rroll}_{33} + {Rroll}_{34} * ( 1 - exp ( \frac{- Fz}{{Rroll}_{35}} ) )$$

$${κ}_{32} = {Rroll}_{36} + {Rroll}_{37} * Fz$$

where the parameters Rrollᵢⱼ are numerical values, V is the speed of the vehicle, deflect is the deflection of the tire, Pg is the inflation pressure of the tire, F_{Z} is the vertical load on the tire, δ is the cornering angle, γ is the camber angle.

Advantageously, the deflection of the tire is determined by way of the following formula:

$$deflect = \frac{{F}_{Z}}{{K}_{ZZ}} + ( \frac{{R}_{eY 1}}{p} + {R}_{eY 2} ) \cdot \vert {F}_{Y} \vert - {R}_{e γ} \cdot \vert γ \vert$$

where K_{ZZ} is the vertical stiffness of the tire with its pneumatic component K_{ZZp} and structural component K_{ZZ0} and K_{ZZ} is written in the form K_{ZZ}=K_{ZZ0}+K_{ZZp}×Pg, F_{Y} is the transverse thrust force exerted on the tire, γ is the camber angle of the vehicle, R_{eγ} is the coefficient of influence of the camber on the deflection, p is the inflation pressure, R_{eY1} is a coefficient which regulates the dependence of the deflection on the transverse thrust force exerted and on the inflation pressure p, and R_{eY2} is a coefficient which regulates the dependence of the deflection on the transverse thrust force exerted without the inflation pressure effect.

Advantageously, the Rrollᵢⱼ values are defined by physical tests on a tire representative of the tire to be designed.

Advantageously, the physical tests are carried out with the aid of a roller of the flat ground type.

Advantageously, the method includes the step of using the TameTire software.

Advantageously, the method comprises the step of using the Rrollᵢⱼ values in the TameTire software.

The invention also relates to a processor for calculating the behaviour of a motor vehicle tire, said processor being configured to estimate an effective rolling radius of the tire, characterized in that it is configured to determine the effective rolling radius Rroll by using a formula of the form:

Rroll=Rroll₁+Rroll₂+Rroll₃,

where:

$${Rroll}_{1} = {Rroll}_{11} - [ ( {κ}_{11} + {κ}_{12} * \frac{deflect}{Pg} ) ] * ( 1 - exp ( \frac{- deflect}{Pg * {Rroll}_{16}} ) )$$

κ₁₁=Rroll₁₂+Rroll₁₃*V

with:

κ₁₂=Rroll₁₄+Rroll₁₅*V

$${Rroll}_{2} = ( {Rroll}_{21} + {Rroll}_{22} * sign ( δ ) * V ) * \frac{1}{{Fz}^{{Rroll}_{23}}} * ( 1 - cos ( \vert δ \vert ) ) - \frac{{Rroll}_{24}}{π} … * ( 1 - exp ( \frac{- Fz}{{Rroll}_{25}} ) ) * \frac{1}{{V}^{{Rroll}_{26}}} … * [ arctan ( {Rroll}_{27} * \vert δ \vert - {Rroll}_{28} * exp ( \frac{- Fz}{{Rroll}_{29}} ) * \frac{1}{{V}^{{Rroll}_{30}}} ) + \frac{π}{2} ] .$$

and:

Rroll₃=(κ₃₁+κ₃₂*sign(δ*γ))*(1−cos(|γ|))

with:

$${κ}_{31} = {Rroll}_{33} + {Rroll}_{34} * ( 1 - exp ( \frac{- Fz}{{Rroll}_{35}} ) )$$

$${κ}_{32} = {Rroll}_{36} + {Rroll}_{37} * Fz$$

where the parameters Rrollᵢⱼ are numerical values, V is the speed of the vehicle, deflect is the deflection of the tire, Pg is the inflation pressure of the tire, F_{Z} is the vertical load on the tire, δ is the cornering angle, γ is the camber angle.

Advantageously, the deflection of the tire is determined by way of the following formula:

$$deflect = \frac{{F}_{Z}}{{K}_{ZZ}} + ( \frac{{R}_{eY 1}}{p} + {R}_{eY 2} ) \cdot \vert {F}_{Y} \vert - {R}_{e γ} \cdot \vert γ \vert$$

where K_{ZZ} is the vertical stiffness of the tire with its pneumatic component K_{ZZp} and structural component K_{ZZ0} and K_{ZZ} is written in the form K_{ZZ}=K_{ZZ0}+K_{ZZp}×Pg, F_{Y} is the transverse thrust force exerted on the tire, γ is the camber angle of the vehicle, R_{eγ} is the coefficient of influence of the camber on the deflection, p is the inflation pressure, R_{eY1} is a coefficient which regulates the dependence of the deflection on the transverse thrust force exerted and on the inflation pressure p, and R_{eY2} is a coefficient which regulates the dependence of the deflection on the transverse thrust force exerted without the inflation pressure effect.

Advantageously, the Rrollᵢⱼ values are defined by physical tests on a tire representative of the tire to be designed.

The invention also relates to a motor vehicle tire, characterized in that it is produced by using a simulation of an effective rolling radius Rᵣₒₗₗ of the tire by way of a formula of the form:

Rroll=Rroll₁+Rroll₂+Rroll₃,

where:

$${Rroll}_{1} = {Rroll}_{11} - [ ( {κ}_{11} + {κ}_{12} * \frac{deflect}{Pg} ) ] * ( 1 - exp ( \frac{- deflect}{Pg * {Rroll}_{16}} ) )$$

κ₁₁=Rroll₁₂+Rroll₁₃*V

with:

κ₁₂=Rroll₁₄+Rroll₁₅*V

$${Rroll}_{2} = ( {Rroll}_{21} + {Rroll}_{22} * sign ( δ ) * V ) * \frac{1}{{Fz}^{{Rroll}_{23}}} * ( 1 - cos ( \vert δ \vert ) ) - \frac{{Rroll}_{24}}{π} … * ( 1 - exp ( \frac{- Fz}{{Rroll}_{25}} ) ) * \frac{1}{{V}^{{Rroll}_{26}}} … * [ arctan ( {Rroll}_{27} * \vert δ \vert - {Rroll}_{28} * exp ( \frac{- Fz}{{Rroll}_{29}} ) * \frac{1}{{V}^{{Rroll}_{30}}} ) + \frac{π}{2} ] .$$

and:

Rroll₃=(κ₃₁+κ₃₂*sign(δ*γ))*(1−cos(|γ|))

with:

$${κ}_{31} = {Rroll}_{33} + {Rroll}_{34} * ( 1 - exp ( \frac{- Fz}{{Rroll}_{35}} ) )$$

$${κ}_{32} = {Rroll}_{36} + {Rroll}_{37} * Fz$$

where the parameters Rrollᵢⱼ are numerical values, V is the speed of the vehicle, deflect is the deflection of the tire, Pg is the inflation pressure of the tire, F_{Z} is the vertical load on the tire, δ is the cornering angle, γ is the camber angle.

Further features, aims and advantages of the invention will become apparent from reading the following description which is given with reference to the appended figures, in which:

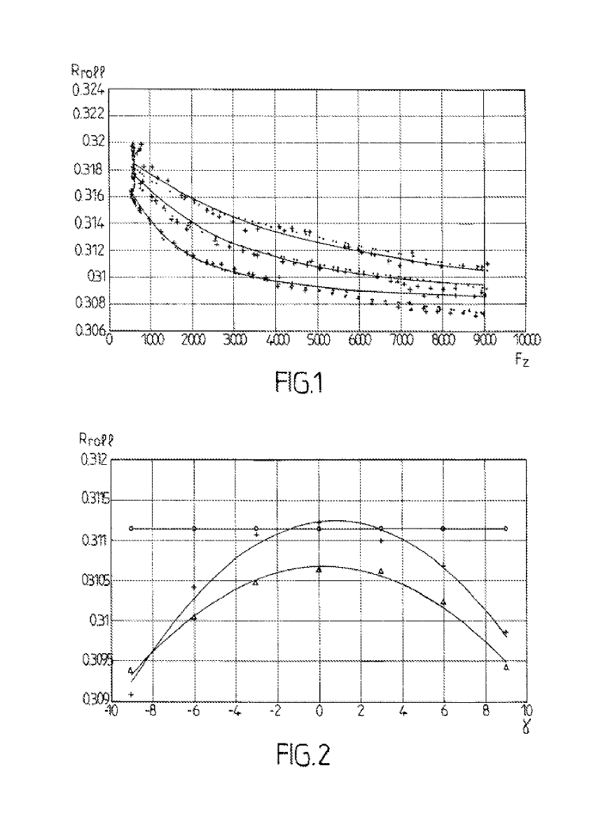

FIG. 1 shows the change in the rolling radius as a function of load, for a tire according to the invention,

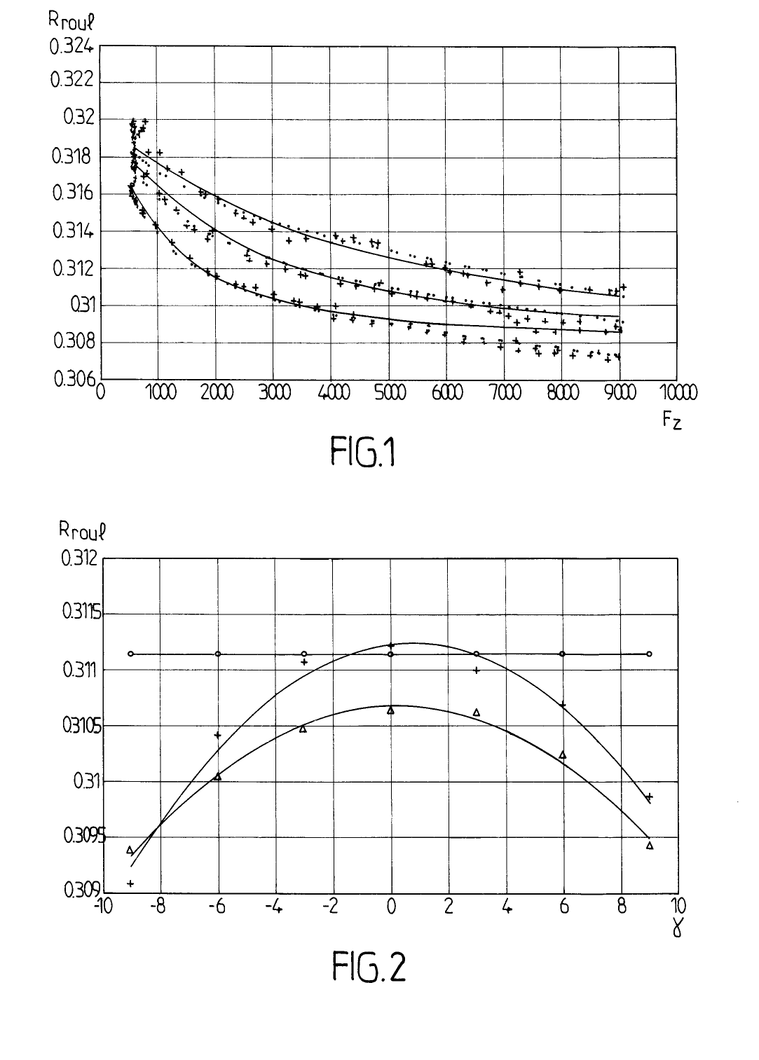

FIG. 2 shows the change in the rolling radius as a function of camber angle, for a tire according to the invention.

The rolling radius of a tire Rᵣₒᵤₗ (m) proves to be dependent on a large number of factors, which include the deflection of the tire, deflect (M) the vertical load on the tire F_{Z}(N), the vertical stiffness of the tire K_{ZZ} (Nm⁻¹) with its pneumatic component K_{ZZp} (Nm⁻¹) and structural component K_{ZZ0} (Nm⁻¹), the rolling speed V(ms⁻¹), the inflation pressure Pg(bar), the transverse thrust force exerted F_{Y}(N),

the camber angle γ(°), the cornering angle δ(°), and the laden radius of the tire Rₗ(m).

All of these quantities should therefore preferably be known, for example measured, in order to find the rolling radius of the tire by way of a mathematical formulation. It is defined with zero engine torque or braking torque. Therefore, the contributions of these various factors will be identified in order then to be able to use the formulation set out below.

In order to assess these phenomena, the following formulation is used here:

Rroll=Rroll₁+Rroll₂+Rroll₃,

where:

$${Rroll}_{1} = {Rroll}_{11} - [ ( {κ}_{11} + {κ}_{12} * \frac{deflect}{Pg} ) ] * ( 1 - exp ( \frac{- deflect}{Pg * {Rroll}_{16}} ) )$$

κ₁₁=Rroll₁₂+Rroll₁₃*V

with:

κ₁₂=Rroll₁₄+Rroll₁₅*V

This first term translates the influences of the load via the deflection, the inflation pressure and the speed on the rolling radius during rolling without turning (or cornering or camber).

$${Rroll}_{2} = ( {Rroll}_{21} + {Rroll}_{22} * sign ( δ ) * V ) * \frac{1}{{Fz}^{{Rroll}_{23}}} * ( 1 - cos ( \vert δ \vert ) ) - \frac{{Rroll}_{24}}{π} … * ( 1 - exp ( \frac{- Fz}{{Rroll}_{25}} ) ) * \frac{1}{{V}^{{Rroll}_{26}}} … * [ arc tan ( {Rroll}_{27} * \vert δ \vert - {Rroll}_{28} * exp ( \frac{- Fz}{{Rroll}_{29}} ) * \frac{1}{{V}^{{Rroll}_{30}}} ) + \frac{π}{2} ] .$$

This second term takes into account the influence of cornering and the terms associated with cornering.

Rroll₃=(κ₃₁+κ₃₂*sign(δ*γ))*(1−cos(|γ|))

with:

$${κ}_{31} = {Rroll}_{33} + {Rroll}_{34} * ( 1 - exp ( \frac{- Fz}{{Rroll}_{35}} ) )$$

$${κ}_{32} = {Rroll}_{36} + {Rroll}_{37} * Fz$$

This 3^{rd} term takes into account the effects of camber and the associated terms connected therewith.

In the case of the rolling radius, Rᵣₒₗₗ(m), the deflection is:

$$deflect = \frac{{F}_{Z}}{{K}_{ZZ}} + ( \frac{{R}_{eY 1}}{p} + {R}_{eY 2} ) \cdot \vert {F}_{Y} \vert - {R}_{e γ } . \vert γ \vert$$

with K_{ZZ}=K_{ZZ0}+K_{ZZp}×Pg

where the following coefficients are introduced. R₁ᵢ are the tire coefficients of the rolling radius which determine the change with pressure, R₂ᵢ are the tire coefficients of the rolling radius which determine the change with speed and load, R₃ᵢ are the tire coefficients of the rolling radius which determine the change with camber, R_{RR}(N/m) is the tire radial stiffness at zero pressure. Also introduced are coefficients which regulate the dependence of the deflection on the transverse thrust force exerted R_{eY2} and also on the pressure R_{ey1}. R_{eγ} is the coefficient of influence of the camber on the deflection.

If the rolling radius of the tire, Rᵣₒₗₗ(m) is less than the laden radius Rₗ (m), the value of the tire rolling radius becomes Rₗ (m).

The strategy of identifying or obtaining the coefficients listed above is based on the one hand on the knowledge of the quantities deflect(m) . . . , Rₗ(m). It is based on the other hand on the creation of an experimental design or measurement animation covering a wide range for each of these quantities, in a generally realistic envelope with respect to the use of the tire. Finally, it is based on the optimization of the set of coefficients by virtue of an appropriate algorithm.

Starting from an animation produced on an appropriate measuring machine, for example a roller of the flat ground type, the knowledge of the responses of the laden radius of the tire as a function of the selected quantities is found.

Since the free radius is the value of the laden radius that is obtained at zero load, it is found by extrapolating the measurement of the laden radius during simple rolling, that is to say without cornering angles, without camber or curvature, or engine or braking torque, at different loads down to a value of zero load. The value of the effective rolling radius at zero load is equivalent to the free radius. FIG. 1 shows the change in the effective rolling radius as a function of load. In FIG. 1, the solid line plots are simulations at different pressures with the formula set out above, and the dashed, dotted and crossed plots are simulations with the formula MF 5.2.

The effect of the pressure on the dependence of the effective rolling radius on the load can be seen in parallel. In this way, the load effect can be found.

It can also be seen that the effective rolling radius varies in a generally linear manner with speed. It can be seen that the change in the rolling radius with speed is not trivial. Specifically, the centrifugal effect and heating effect for example can be compensated depending on the thermomechanical state of the tire for example.

As regards the cornering angle effect, it can be seen that the effective rolling radius also varies with the cornering angle. These variations can present, at medium and high loads, a fairly abrupt jump for cornering angles of around 1 degree.

The laden radius also varies with the camber angle, as illustrated in FIG. 2. In FIG. 2, the curved plots represent the results obtained by measurement and with the proposed model, and the substantially horizontal plot represents the results obtained with the MF 5.2 model.

The above observations are then integrated into a strategy for obtaining the coefficients of the laden radius model. A strategy for obtaining the coefficients of the deflection and thus transverse load model is also created. These strategies comprise various steps which can be repeated iteratively in order to improve the correspondence between the model and the reference measurement. The effective rolling radius model and transverse load model are integrated into an overall TameTire model that makes it possible to take the reciprocal interactions of one with the other into account.

The TameTire model is a thermomechanical model developed to improve the prediction of the forces at the wheel center for studies of the behaviour of the vehicle. The main motivation comes from the observation that mathematical models of the Magic Formula type do not take into account the effects of temperature or of speed which are significant for tire forces. In particular, these models are only valid, a priori, in the field of measurement in which they are applicable and do not allow reliable extrapolations when a simulation of different manoeuvres of the vehicle is desired. The TaMeTirE model calculates the longitudinal and lateral forces as a function of physical quantities of the tire such as the size of the area of contact, rigidity of the sidewalls, of the crown block, of the tread, properties of the rubber and friction characteristics. The characteristics of the combination of modulus and coefficient of grip are associated with the temperatures of the tire.

The formulation presented in this embodiment makes it possible to find a relatively simple expression, by way of a mathematical model, for the effective rolling radius value of a tire as a function of relevant quantities that are easily measurable on a mechanical test machine, via a set of coefficients that is accessible by way of rapid optimization.

The use of such a formulation is then based on the knowledge of the quantities involved, which are, in a simulation tool, either input quantities such as load, speed, pressure, camber, or quantities that are dependent on the tire such as deflection or transverse load. These intermediate quantities should be able to be deduced from the input quantities in order to realize a simulation.

An expression of the effective rolling radius which also incorporates the effects of the internal temperature and the surface temperature, but also those of cornering and camber, is thus found, this expression being usable directly in a simulation tool. Better modelling of the effective rolling radius, in particular taking the cornering and camber angles into account, is then found.

The results show greater acuity of the model proposed here compared with known models. The effective rolling radius model becomes more precise, this being of great benefit in the management of acceleration and braking operations at the limits of grip. Specifically, this optimal limit is achieved for a particular level of slip, and it is thus crucial to control this quantity, for example for an ABS system, a skid prevention system or even a calculation of the “launch control” type. The effective rolling radius model then makes it possible to fully exploit the advantages of the TameTire model for calculating the longitudinal load, taking into account the thermal effects, the speed of calculation and the relevance associated with the physical bases of this model.

The whole can be implemented within software for simulating the dynamics of vehicles in order to carry out more realistic manoeuvres, in particular in situations at the limits of longitudinal grip of the vehicle, such as safety manoeuvres of the emergency braking type or performance manoeuvres of the standing start type. The preselection of components of the vehicle such as connections to the ground, tires, or the adjustment thereof, for example by way of connections to the ground or by way of the ESP (Electronic Stability Program), or by way of ABS or skid prevention, can then be carried out more effectively.

1-10. (canceled)

11: A method for producing a motor vehicle tire, the method comprising:
estimating an effective rolling radius Rᵣₒₗₗ of the tire by using a formula having a form of:
Rroll=Rroll₁+Rroll₂+Rroll₃,
where:
$${Rroll}_{1} = {Rroll}_{11} - [ ( {κ}_{11} + {κ}_{12} * \frac{deflect}{Pg} ) ] * ( 1 - exp ( \frac{- deflect}{Pg * {Rroll}_{16}} ) ) ,$$
κ₁₁=Rroll₁₂+Rroll₁₃*V
with:
κ₁₂=Rroll₁₄+Rroll₁₅*V,
$${Rroll}_{2} = ( {Rroll}_{21} + {Rroll}_{22} * sign ( δ ) * V ) * \frac{1}{{Fz}^{{Rroll}_{23}}} * ( 1 - cos ( \vert δ \vert ) ) - \frac{{Rroll}_{24}}{π} … * ( 1 - exp ( \frac{- Fz}{{Rroll}_{25}} ) ) * \frac{1}{{V}^{{Rroll}_{26}}} … * [ arc tan ( {Rroll}_{27} * \vert δ \vert - {Rroll}_{28} * exp ( \frac{- Fz}{{Rroll}_{29}} ) * \frac{1}{{V}^{{Rroll}_{30}}} ) + \frac{π}{2} ] ,$$
and:
Rroll₃=(κ₃₁+κ₃₂*sign(δ*γ))*(1−cos(|γ|)),
with:
$${κ}_{31} = {Rroll}_{33} + {Rroll}_{34} * ( 1 - exp ( \frac{- Fz}{{Rroll}_{35}} ) )$$
$${κ}_{32} = {Rroll}_{36} + {Rroll}_{37} * Fz ,$$
where parameters Rrollᵢⱼ are numerical values, V is a speed of the vehicle, deflect is a deflection of the tire, Pg is an inflation pressure of the tire, F_{Z} is a vertical load on the tire, δ is a cornering angle, and γ is a camber angle of the vehicle.

12: The method according to claim 11, wherein the deflection of the tire is determined by a formula having a form of:
$$deflect = \frac{{F}_{Z}}{{K}_{ZZ}} + ( \frac{{R}_{eY 1}}{p} + {R}_{eY 2} ) \cdot \vert {F}_{Y} \vert - {R}_{e γ } . \vert γ \vert ,$$
where:
K_{ZZ} is a vertical stiffness of the tire, with K_{ZZp} being a pneumatic component of the tire, with K_{ZZ0} being a structural component of the tire, and with K_{ZZ} having a form of:
K_{ZZ}=K_{ZZ0}+K_{ZZp}×Pg,
F_{Y} is a transverse thrust force exerted on the tire,
γ is the camber angle of the vehicle,
R_{eγ} is a coefficient of influence of the camber angle of the vehicle on the deflection of the tire,
p is the inflation pressure of the tire,
R_{eY1} is a coefficient that regulates a dependence of the deflection of the tire on the transverse thrust force F_{Y} exerted the tire and on the inflation pressure p of the tire, and
R_{eY2} is a coefficient that regulates a dependence of the deflection of the tire on the transverse thrust force F_{Y} exerted on the tire without an inflation pressure effect.

13: The method according to claim 11, wherein the parameters Rrollᵢⱼ are numerical values defined by physical tests on a tire representative of the tire being produced.

14: The method according to claim 13, wherein the physical tests are carried out using a roller of a flat ground type.

15: The method according to claim 11, further comprising:
using software for simulating force dynamics at a wheel center.

16: The method according to claim 15, wherein the parameters Rrollᵢⱼ are numerical values used in the software for simulating the force dynamics at the wheel center.

17: A processor for determining a behaviour of a tire being produced for a motor vehicle, the processor being programmed to perform a method comprising:
estimating an effective rolling radius Rᵣₒₗₗ of the tire by using a formula having a form of:
Rroll=Rroll₁+Rroll₂+Rroll₃,
where:
$${Rroll}_{1} = {Rroll}_{11} - [ ( {κ}_{11} + {κ}_{12} * \frac{deflect}{Pg} ) ] * ( 1 - exp ( \frac{- deflect}{Pg * {Rroll}_{16}} ) ) ,$$
κ₁₁=Rroll₁₂+Rroll₁₃*V
with:
κ₁₂=Rroll₁₄+Rroll₁₅*V,
$${Rroll}_{2} = ( {Rroll}_{21} + {Rroll}_{22} * sign ( δ ) * V ) * \frac{1}{{Fz}^{{Rroll}_{23}}} * ( 1 - cos ( \vert δ \vert ) ) - \frac{{Rroll}_{24}}{π} … * ( 1 - exp ( \frac{- Fz}{{Rroll}_{25}} ) ) * \frac{1}{{V}^{{Rroll}_{26}}} … * [ arc tan ( {Rroll}_{27} * \vert δ \vert - {Rroll}_{28} * exp ( \frac{- Fz}{{Rroll}_{29}} ) * \frac{1}{{V}^{{Rroll}_{30}}} ) + \frac{π}{2} ] ,$$
and:
Rroll₃=(κ₃₁+κ₃₂*sign(δ*γ))*(1−cos(|γ|)),
with:
$${κ}_{31} = {Rroll}_{33} + {Rroll}_{34} * ( 1 - exp ( \frac{- Fz}{{Rroll}_{35}} ) )$$
$${κ}_{32} = {Rroll}_{36} + {Rroll}_{37} * Fz ,$$
where parameters Rrollᵢⱼ are numerical values, V is a speed of the vehicle, deflect is a deflection of the tire, Pg is an inflation pressure of the tire, F_{Z} is a vertical load on the tire, δ is a cornering angle, and γ is a camber angle of the vehicle.

18: The processor according to claim 17, wherein the deflection of the tire is determined by a formula having a form of:
$$deflect = \frac{{F}_{Z}}{{K}_{ZZ}} + ( \frac{{R}_{eY 1}}{p} + {R}_{eY 2} ) \cdot \vert {F}_{Y} \vert - {R}_{e γ } . \vert γ \vert ,$$
where:
K_{ZZ} is a vertical stiffness of the tire, with K_{ZZp} being a pneumatic component of the tire, with K_{ZZ0} being a structural component of the tire, and with K_{ZZ} having a form of:
K_{ZZ}=K_{ZZ0}+K_{ZZp}×Pg,
F_{Y} is a transverse thrust force exerted on the tire,
γ is the camber angle of the vehicle,
R_{eγ} is a coefficient of influence of the camber angle of the vehicle on the deflection of the tire,
p is the inflation pressure of the tire,
R_{eY1} is a coefficient that regulates a dependence of the deflection of the tire on the transverse thrust force F_{Y} exerted the tire and on the inflation pressure p of the tire, and
R_{eY2} is a coefficient that regulates a dependence of the deflection of the tire on the transverse thrust force F_{Y} exerted on the tire without an inflation pressure effect.

19: The processor according to claim 17, wherein the parameters Rrollᵢⱼ are numerical values defined by physical tests on a tire representative of the tire being produced.

20: The processor according to claim 18, wherein the parameters Rrollᵢⱼ are numerical values defined by physical tests on a tire representative of the tire being produced.

21: A tire for a motor vehicle tire, the tire being produced by a simulation method comprising:
estimating an effective rolling radius Rᵣₒₗₗ of the tire by using a formula having a form of:
Rroll=Rroll₁+Rroll₂+Rroll₃,
where:
$${Rroll}_{1} = {Rroll}_{11} - [ ( {κ}_{11} + {κ}_{12} * \frac{deflect}{Pg} ) ] * ( 1 - exp ( \frac{- deflect}{Pg * {Rroll}_{16}} ) ) ,$$
κ₁₁=Rroll₁₂+Rroll₁₃*V
with:
κ₁₂=Rroll₁₄+Rroll₁₅*V,
$${Rroll}_{2} = ( {Rroll}_{21} + {Rroll}_{22} * sign ( δ ) * V ) * \frac{1}{{Fz}^{{Rroll}_{23}}} * ( 1 - cos ( \vert δ \vert ) ) - \frac{{Rroll}_{24}}{π} … * ( 1 - exp ( \frac{- Fz}{{Rroll}_{25}} ) ) * \frac{1}{{V}^{{Rroll}_{26}}} … * [ arc tan ( {Rroll}_{27} * \vert δ \vert - {Rroll}_{28} * exp ( \frac{- Fz}{{Rroll}_{29}} ) * \frac{1}{{V}^{{Rroll}_{30}}} ) + \frac{π}{2} ] ,$$
and:
Rroll₃=(κ₃₁+κ₃₂*sign(δ*γ))*(1−cos(|γ|)),
with:
$${κ}_{31} = {Rroll}_{33} + {Rroll}_{34} * ( 1 - exp ( \frac{- Fz}{{Rroll}_{35}} ) )$$
$${κ}_{32} = {Rroll}_{36} + {Rroll}_{37} * Fz ,$$
where parameters Rrollᵢⱼ are numerical values, V is a speed of the vehicle, deflect is a deflection of the tire, Pg is an inflation pressure of the tire, F_{Z} is a vertical load on the tire, δ is a cornering angle, and γ is a camber angle of the vehicle.
